(19) United States
(12) Patent Application Publication
(10) Pub. No.: US 2017/0061733 A1
(43) Pub. Date: Mar. 2, 2017

(54) SOCIAL GAME WITH PRIZE FEATURES

(71) Applicant: CAVU STUDIOS, INC., Santa Ana, CA (US)

(72) Inventors: Jonathan Logan Gulla, Laguna Beach, CA (US); Kurt Kelly Belcher, Santa Ana, CA (US)

(21) Appl. No.: 15/250,793

(22) Filed: Aug. 29, 2016

Related U.S. Application Data
(60) Provisional application No. 62/211,200, filed on Aug. 28, 2015.

(51) Int. Cl. G07F 17/32; A63F 13/332; A63F 13/335; A63F 13/35; A63F 13/80

(52) U.S. Cl. CPC G07F 17/3244; A63F 13/35; A63F 13/80; G07F 17/3241; G07F 17/3211; A63F 13/335; A63F 13/332; G07F 17/3225

(57) ABSTRACT

Systems, methods and devices for promoting a social gaming environment including a computer readable medium storing instructions which, when executed by a processor, cause the processor to send media content messages to a friend's device, including prizes.

### CROSS-REFERENCE TO RELATED APPLICATIONS

The present application claims priority to U.S. Provisional Application No. 62/211,200 filed Aug. 28, 2015, titled “SOCIAL GAME. WITH PRIZE FEATURES,” which is hereby incorporated by reference in its entirety.

### FIELD

The subject matter described herein relates generally to systems and methods for communication, prize awarding, prize forwarding and messaging in a social gaming environment.

### BACKGROUND

Computer games began with simple concepts and were largely limited to competition on a single screen. Over time, they have evolved to require complex computations performed over distributed computing environments involving hundreds or thousands of individual machines communicating over worldwide networks such as the Internet in order to achieve complex goals, involving even more complex strategies. While some monetization has existed in the gaming industry, it has largely been limited to in-game advertising, sales of subscription services by game developers, operation of virtual stores within virtual worlds and other, similar commercial offshoots. As such, there has been little or no integration between computer games featuring virtual environments and the real-world. With a worldwide value in the tens of billions of dollars per annum, the gaming industry is a largely untapped resource for retailers which are generally not associated with the gaming space.

Thus, needs exist for improved techniques by which to integrate real-world commercial value into virtual reality worlds.

### SUMMARY

Provided herein are embodiments of systems and methods for systems and methods of integrating commercial aspects into virtual reality worlds.

The embodiments disclosed herein detail a social gaming environment in which a user can create or select media for inclusion in a friend's gaming environment. This promotes a social gaming aspect which encourages sharing with friends. Additionally, users can find prizes in game with real-world utility and thus should be more inclined to return to the game.

The configuration of the systems and methods described herein in detail are only example embodiments and should not be considered limiting. Other systems, methods, features and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A shows an example embodiment diagram of a system flowchart.

FIG. 1B shows an example embodiment diagram of a system architecture.

FIG. 1C shows an example embodiment diagram of a server architecture.

FIG. 1D shows an example embodiment diagram of a user mobile device.

FIG. 1E shows an example embodiment of a general system operation flowchart.

FIG. 2 shows an example embodiment diagram of a user interface login screen.

FIG. 3 shows an example embodiment diagram of a user interface “friend” sharing selection screen.

FIG. 4 shows an example embodiment diagram of a user interface “friend” image and caption sharing screen.

FIG. 5 shows an example embodiment diagram of a user interface “friend” image and caption sharing screen.

FIG. 6 shows an example embodiment diagram of a user interface “friend” image and caption sharing screen.

FIG. 7 shows an example embodiment diagram of a user interface “friend” image and caption sharing screen.

FIG. 8 shows an example embodiment diagram of a user interface in-game location selection screen.

FIG. 9 shows an example embodiment diagram of a user interface in-game location selection confirmation screen.

FIG. 10 shows an example embodiment diagram of a user interface in-game screen with commercial prize.

FIG. 11 shows an example embodiment diagram of a user interface user notification screen.

FIG. 12 shows an example embodiment diagram of a user interface commercial prize claim screen.

FIG. 13 shows an example embodiment diagram of a user interface commercial prize sharing screen.

FIG. 14 shows an example embodiment diagram of a user interface commercial prize sharing screen.

FIG. 15 shows an example embodiment diagram of a user interface commercial prize sharing screen.

FIG. 16 shows an example embodiment diagram of a user interface in-game location selection screen.

FIG. 17 shows an example embodiment diagram of a user interface in-game location selection confirmation screen.

FIG. 18 shows an example embodiment diagram of a user interface in-game screen with commercial prize.

FIG. 19 shows an example embodiment diagram of a user interface in-game screen with “friend” interaction.

FIG. 20 shows an example embodiment diagram of a user interface user notification screen.

FIG. 21 shows an example embodiment diagram of a user interface user notification screen.

FIG. 22 shows an example embodiment diagram of a user interface messaging screen with hyperlink sharing functionality.

FIG. 23 shows an example embodiment diagram of a user interface messaging screen with hyperlink functionality.

FIG. 24 shows an example embodiment diagram of a user interface in-game location selection screen.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

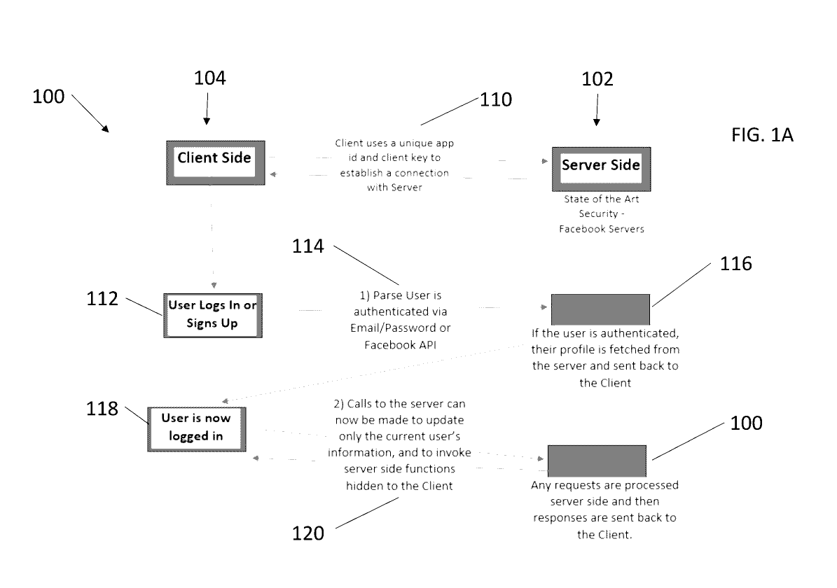

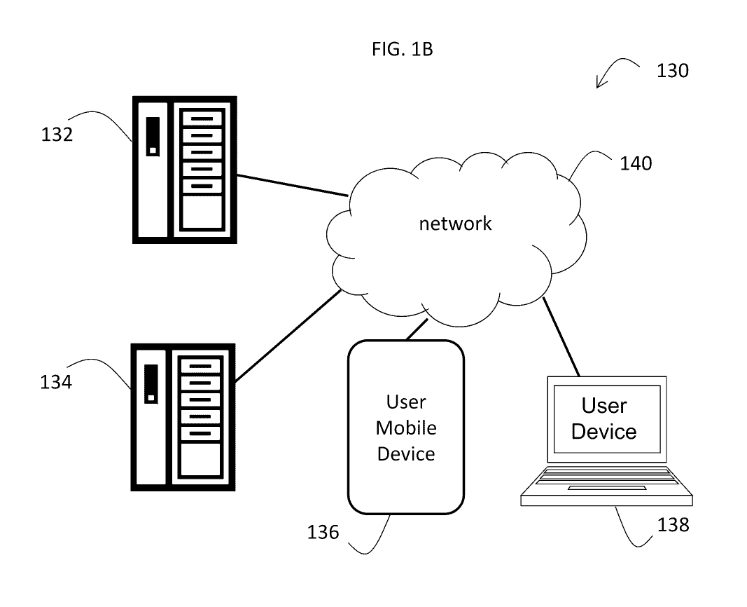

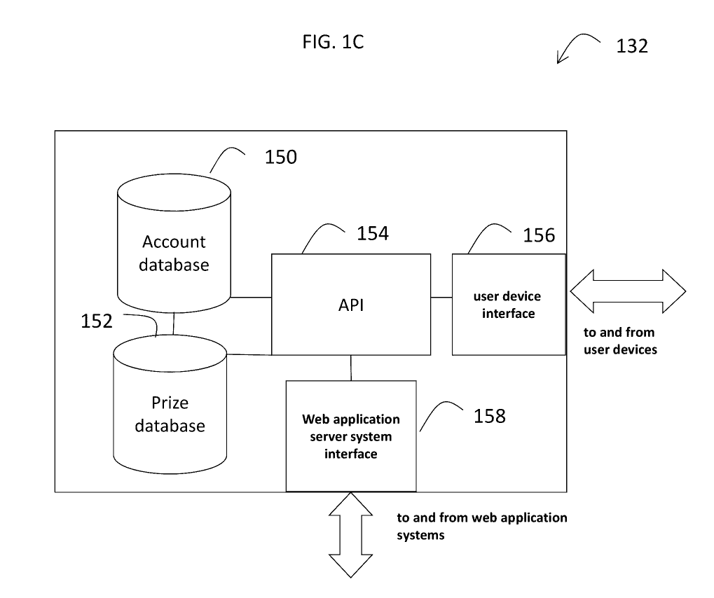

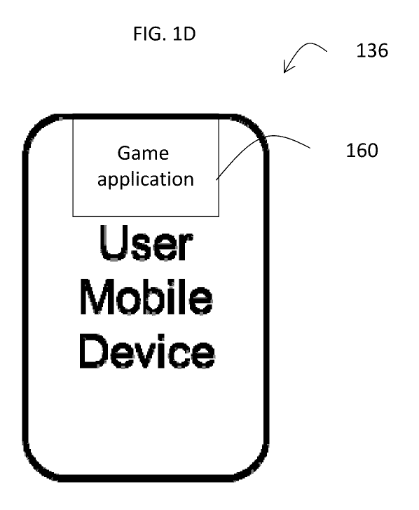

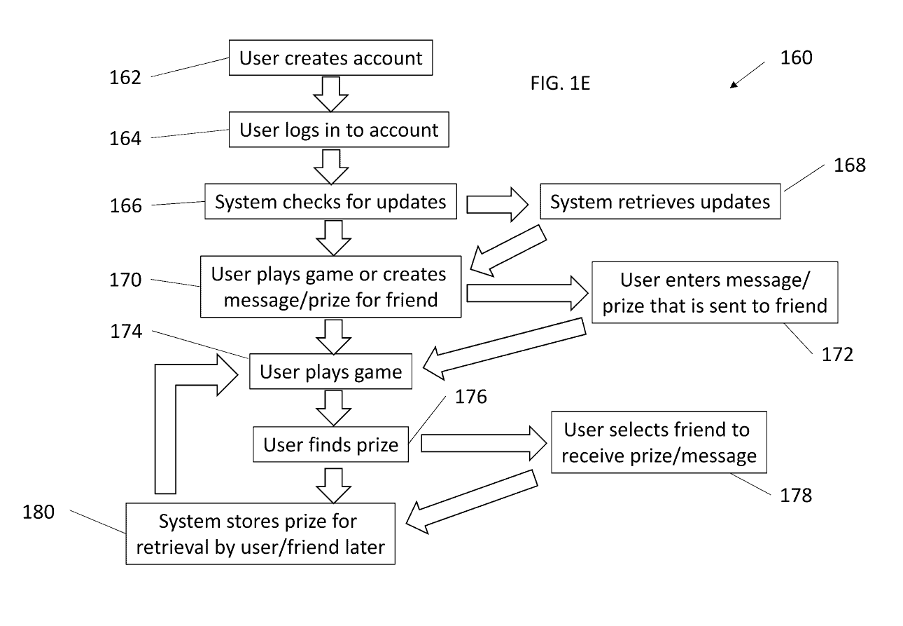

FIG. 1A shows an example embodiment diagram of a system flowchart 100. In the example embodiment the server side 102 including a server and client side 104 including a client device are both shown. Initially, a user can establish a connection between the device client side 104 with server side 102 via a network and download an application in step 110. Then, the user at client side 104 can use the device can to receive a unique application identifier and a client key to establish a connection with a server at server side 102. The server can include state of the art security, as is provided by Facebook, other third party providers, proprietary security or other server security. The user can then create a log in or other sign up for the system or, if previously signed up, can log in using their username at client side 104 during step 112, which is sent via the network to server side 102. The system can then parse or otherwise check the username and authenticate the user login via email and password or using a Facebook API in step 114. At server side 102, if the user is authenticated, their profile can be fetched from the server and sent back to the client via the network in step 116. The user is then logged in at client side 104 where calls to the server at server side 102 can be made via the network to update the user's current information and invoke other server side 102 functions, hidden to client side 104 in step 120. Any requests from client side 104 are processed at server side 102 and then responses are sent back to client side 104 via the network as required until the user logs out of the system on client side 104 via steps 122. As described herein, in various embodiments where a user sends messages, content or prizes to one or more friends, these can be stored on the server until the one or more friends log into the system on client devices. At that point they can be pushed to the friends' respective user device.

Mobile applications, mobile devices such as smart phones/tablets/wearable devices, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers and others equipment, components and devices as appropriate to implement the methods and systems described herein are contemplated.

FIG. 1B shows an example embodiment diagram of a system architecture 130. As shown in the example embodiment, this can include multiple servers 132, 134 which may include applications distributed on one or more physical servers, each having one or more processors, non-transitory computer readable media memory banks, operating systems, input/output interfaces, and network interfaces, all known in the art, and a plurality of end user devices coupled to a network 140 such as a public network (e.g. the Internet and/or a cellular-based wireless network or other networks) or a private network. User devices 136, 138 can include, for example, mobile devices (e.g. phones, tablets and others) desktop or laptop devices, wearable devices (e.g. watches, bracelets, glasses and others), other devices with computing capability and network interfaces and so on. The server systems can include, for example, servers 132, 134 operable to interface with websites, webpages, web applications, social media platforms, advertising platforms and others.

FIG. 1C shows an example embodiment diagram of a server architecture 132. As shown in the example embodiment, a server system can include at least one user device interface 156 implemented with technology known in the art for communication with user devices. The server system can include at least one web application server system interface 158 for communication with web applications, websites, webpages, websites, social media platforms, and others. The server system can further include an application program interface (API) 154 that is coupled to at least one database, such as Account database 150, Prize database 152 and others and can communicate with interfaces such as the user device interface 156 and web application server system interface 158, or others. API 154 may instruct the databases 150, 152 to store (and retrieve from the databases) information such as link or URL information, user account information, associated account information, or others as appropriate. Databases 150, 152 may be implemented with technology known in the art such as relational databases and/or object oriented databases or others.

FIG. 1D shows an example embodiment diagram of a user mobile device 136. As shown in the example embodiment, user devices 136 can include a network connected game application 190 that is installed in, pushed to or downloaded and stored in non-transitory computer readable memory of the user mobile device 136. In many embodiments, user devices are touch screen devices such as smartphones and tablet computers that include one or more processors, operable to execute instructions stored in non-transitory computer readable memory of the device.

FIG. 1E shows an example embodiment of a general system operation flowchart 160. As shown in the example embodiment, a user can first create an account if they do not have one in step 162. The user can log in to the account in step 164 and the system can check for updates in step 166. In step 168, the system can retrieve any updates before the user can play the game or create prizes or messages to friends in step 170. If the user elects to enter a message or create or send a prize for a friend, the system can accomplish this in step 172. The user can play a game in step 174 until finding a prize in step 176. After finding the prize, a user can select a friend to receive the message if they choose in step 178. The system can store the prize for retrieval by the user or friend at a later time in step 180 and the user can continue playing the game in returning to step 174.

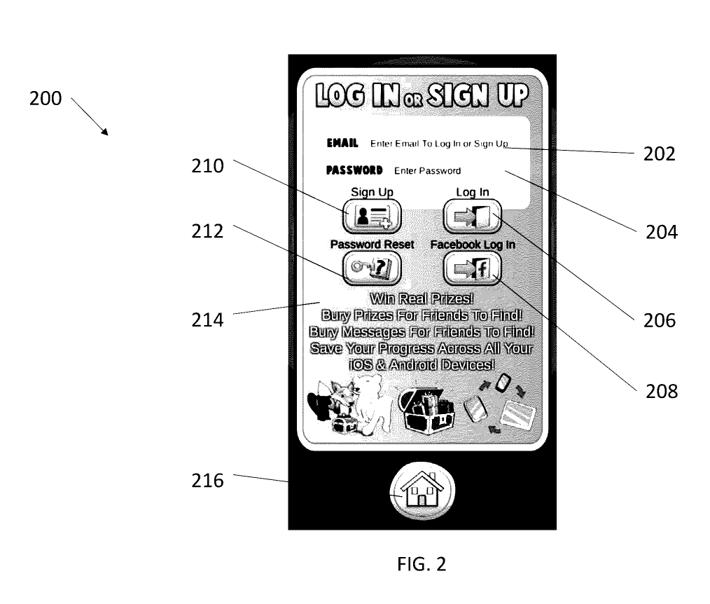

FIG. 2 shows an example embodiment diagram of a user interface login screen 200. As shown, information and instructions can be described in a non-interactive information field 214. As shown, this can include descriptions of application functions. Here this includes the statements “Win Real Prizes! Bury Prizes For Friends To Find! Bury Messages For Friends To Find! Save Your Progress Across All Your iOS & Android Devices!” In some embodiments, these can be selectable buttons that will show brief descriptions of the functions if selected by a user using a user interface.

In the example embodiment a user can log in to the system using an email and password by entering information via a user interface in their corresponding email/username field 202 and password field 204 and selecting a log in button 206. It should be understood that other login methods are contemplated including username and password, biometric sign in using fingerprints, eye scans or other techniques including appropriate hardware and software on appropriate devices and others. Additionally, log-ins using third party system linking can be used. For instance, a user can link an account to a Facebook account, Twitter account, LinkedIn or other social network by selecting a third-party login button 208. In some embodiments, users can reset a forgotten password by selecting a password reset button 212. Users can also create an account if they do not have one on the system, such as by inputting an email or other username and password after selecting a sign-up button 210. In various embodiments a single account can be used over multiple devices. For example, a user can engage the system on one device such as a smartphone, logout and then engage the system on another device such as a tablet.

To elaborate, a “SignUpNewUser” function can be selected by selecting a Sign Up button 210. This function can allow a user to transmit required information from a user device (e.g. 136, 138 of FIG. 1B) to system servers (e.g. 132, 134 of FIG. 1B) via a network (e.g. 140 of FIG. 1B) in order to create or sign up for a new account. If all transmitted information is valid or acceptable, then a new user account can be created in an account database. Validity or acceptability of information can be determined by passing the information through a three step process which ensures the data is real and unique. First, the client side code, executed by a processor, can check to ensure certain aspects of the data are legitimate. For example, email addresses must contain a “@” and “.” symbol with characters coming before, in between and after these symbols. This data can be sent from the device to the server via a network, where the server backend can first determine whether a requesting user is logged into the system with a valid session token. Then the entered data can be checked by the server to ensure it is legitimate for the purpose it has been entered on the server side. For example, if the data is information related to a user signing up for the system, the server can check if the username and email are unique by comparing with username and password data stored in a non-transitory database (e.g. Account database 150 of FIG. 1C) to avoid duplicate accounts.

Required information can include a user's email address which is visible in the system, and a password which is not visible in the system to anyone.

A “LogInAUser” function can be selected by selecting a Log In button 206. This function can include a user inputting their email address and password into the appropriate fields 202, 204 that associated with a user account which the system checks against a database. If the information matches the information checked in the database then access can be granted to the user's game data.

A “CheckIfThisUserAlreadyExists” function can be a helper function to properly check if a user has linked a Facebook account when a user tries to log in via a Facebook Log In button 208. The system can check to see if the user's game data shows they have linked a Facebook account before logging them in using that information. Otherwise the system can log the user in with their email address before doing a linking process.

Also shown in FIG. 2 is a home button 216 that can bring up a user interface home screen of the application.

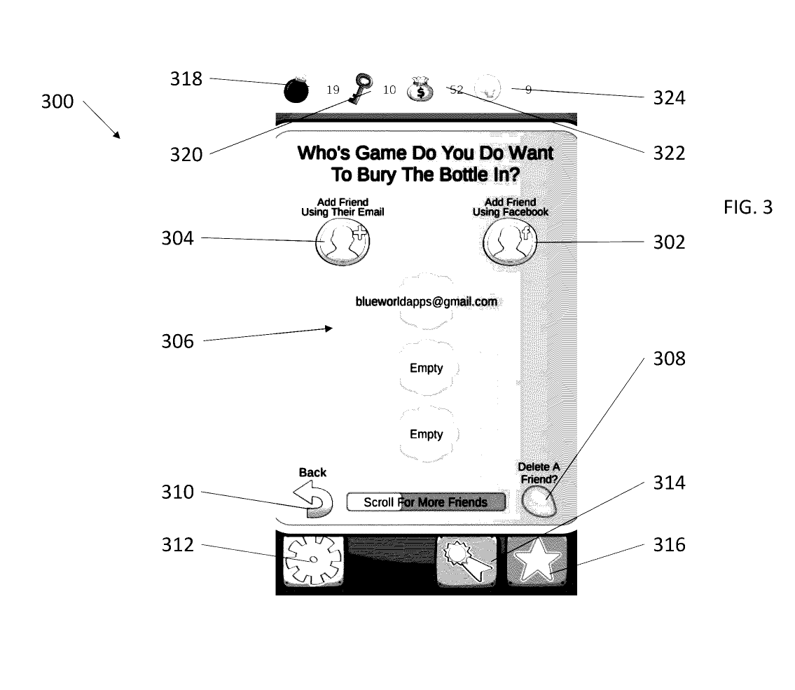

FIG. 3 shows an example embodiment diagram of a user interface “friend” sharing selection screen 300. In the example embodiment a user can share content with other users they are associated with, “friends.” Friends can be added using third party applications such as social networks by selecting an add friend by third party application button 302, using email addresses by selecting an add friend by email button 304 or by other techniques such as in-game, by telephone number, by IP address, using NFC or RF linking of user devices or many others. A list of friends 306 is shown and a user has the opportunity to select one or more, delete one or more by selecting a delete button 308, scroll to view additional friends or go back to a previous screen such as a home screen by selecting a back button 310. Also available are other selectable buttons such as a settings button 312, rewards/prizes/achievements button 314, goals button 316 and specific in-game status icon indicators including quantities, such as weapons 318, keys 320, money 322, lives 324, and others. Selection of these buttons or fields can display related information, buttons and fields.

In some embodiments a “GrabTheRightPrize” function can be used. This function can allow the user to request a random prize from a system prize pool which is stored in a database (e.g. Prize database 152 of FIG. 1C) on the server system. The system can then place a prize in the user's game data, for instance by sending to a client device. In some embodiments, the system can determine if the user already has a prize in their saved game data by checking their stored user account information (e.g. as stored in Account Database 150 of FIG. 1C) and also determine if there are prizes in the prize pool. If the user already has a prize in their game data or if there are no prizes left in the pool, then the user will not receive the requested prize.

In some embodiments, a friend adding process can be called using an “AddFriendToMyList” function and can include a user inputting an email address of a friend into the server system using a user interface of a user device. This information can be added in appropriate fields (not shown) after a user selects an “Add Friend Using Their Email” button 304. The server system can receive this information via the network and compare the inputted email address to a list of email addresses in a database (e.g. Account Database 150 of FIG. 1C) to determine if the email address has been used to create an account with the system. If a match is found, then each user is added to the other's friend list or a confirmation can be sent to the found email address account, in order to ensure the found email account holder wishes to be friends with the requesting user. If no match is found, then a new default account can be set up for the new email address that can allow messages and prizes to be sent to the new account. The system can send the friend an email informing them to download and install the application on their user device, use their email address as an account name and enter a default password, such as “abc123,” to log in for the first time. Once the friend does this, they can be presented with a screen requiring them to enter their own unique password to continue. After continuing, the friend can discover treasures in the game and receive messages sent to them through the game system by the friend who signed them up initially and from any other friends who used the email address after the initial sign up to add the same person to their friend list.

An “UpdatePassword” function can be a helper function used when a user enters the default password to log into the server system for the first time, after their account is auto-created by a friend's request. This function can ensure the user is valid and replace the default password with a new password.

In some embodiments a feature can be called “SendEmailToUser.” When a user finds a prize in their game and wishes to claim the prize from the server system, the system can send them a prize identifier number which is associated with a user identifier. This identifier can be checked against a prize identifier database (e.g. Prize database 152 of FIG. 1C) and must match an identifier number of the prize given to the user from the “GrabTheRghtPrize” function. If the user identifier is valid and matches the associated prize, the user can receive an email sent by the system to their registered email address with the prize's claim process information, or link, as provided by a Company or other entity that is associated with the prize.

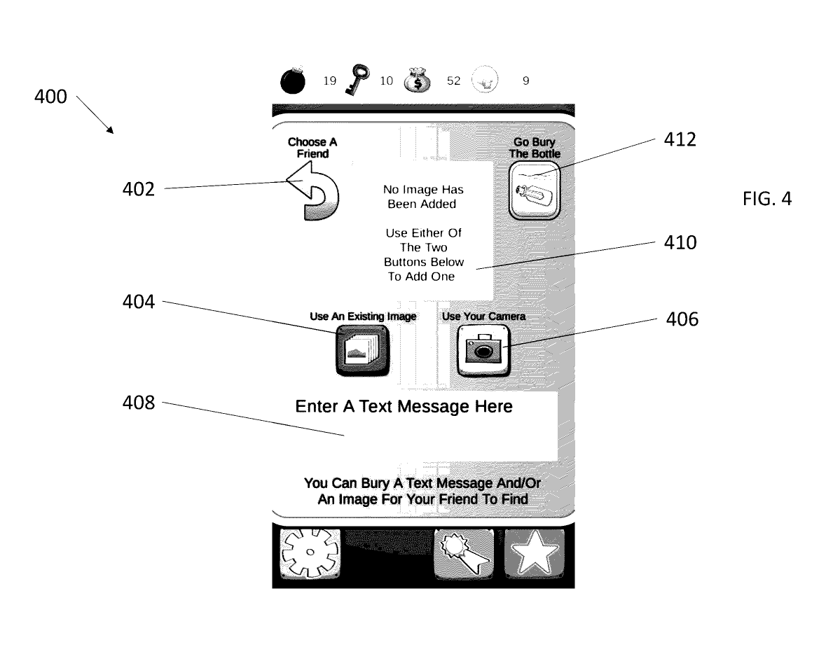

Once a user has selected one or more friends to send a message to, the system can display a “friend” image and caption sharing screen, as shown in the example embodiment of FIG. 4.

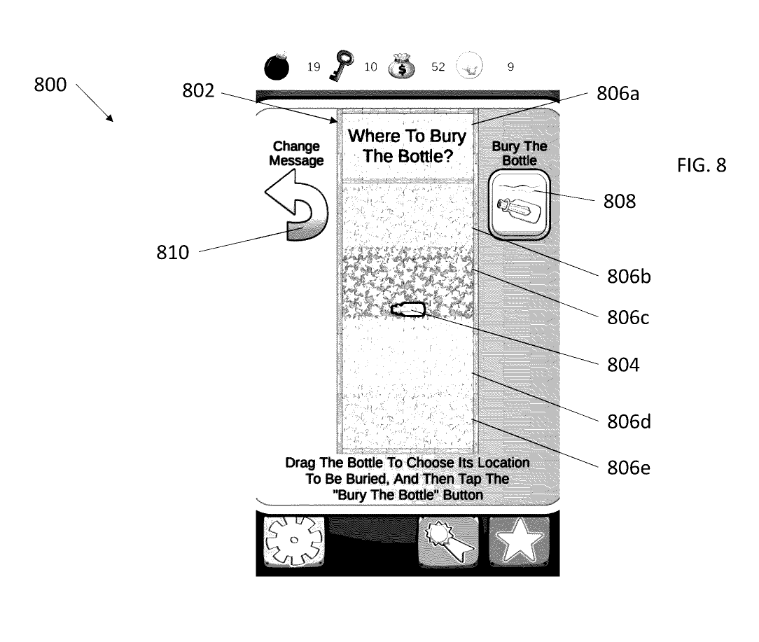

FIG. 4 shows an example embodiment diagram of a user interface “friend” image and caption sharing screen 400. In the example embodiment a back button 402 allows a user to return to a previous screen and select one or more different friends to engage. Users can have the opportunity to include an existing image stored in non-transitory device memory by selecting a use an existing image button 404, use a device camera to capture an image by selecting a use your camera button 406 and enter text messages in a text message field 408 by using a device interface. Additional functionality is contemplated in other embodiments including using voice recordings or songs, video clips or captured videos, links to websites and other content. Users can then preview a prize bottle in image window 410 and implant their chosen content into their friend's game by selecting a go bury the bottle button 412. In the example embodiment this is done by selecting “Go Bury the Bottle” button 412, although in other embodiments this can be done in various other ways. For instance, in some embodiments, a plane could fly through a friend's game and drop a crate containing the content, a popup could appear on a virtual handheld containing the content, a messenger character could deliver a parchment including the content, or any number of other notification techniques can be used. Selecting the “Go Bury the Bottle” button 412 can take the user to a user interface in-game location selection screen (e.g. 800 of FIG. 8).

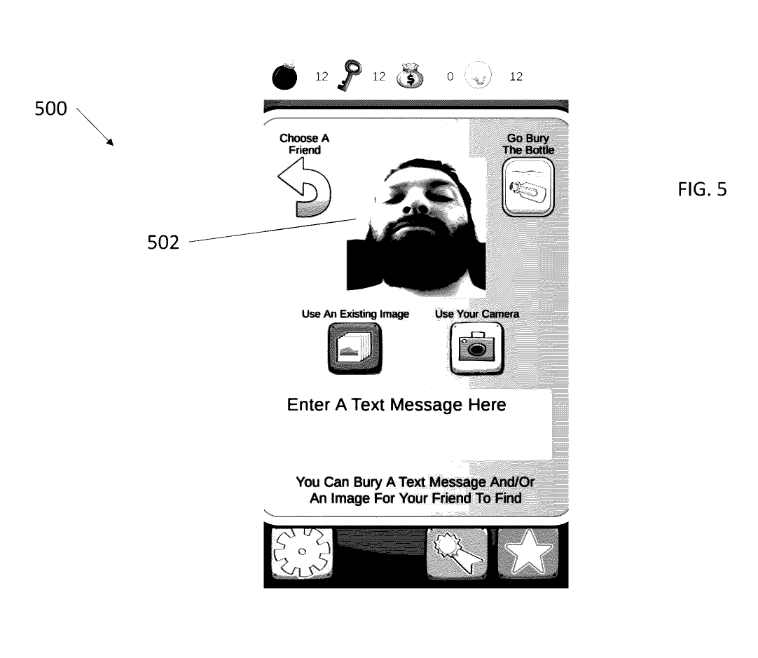

FIG. 5 shows an example embodiment diagram of a user interface “friend” image and caption sharing screen 500. In the example embodiment a user has taken a self-image—a “selfie”—to be included in a friend's game, as displayed in image window 502.

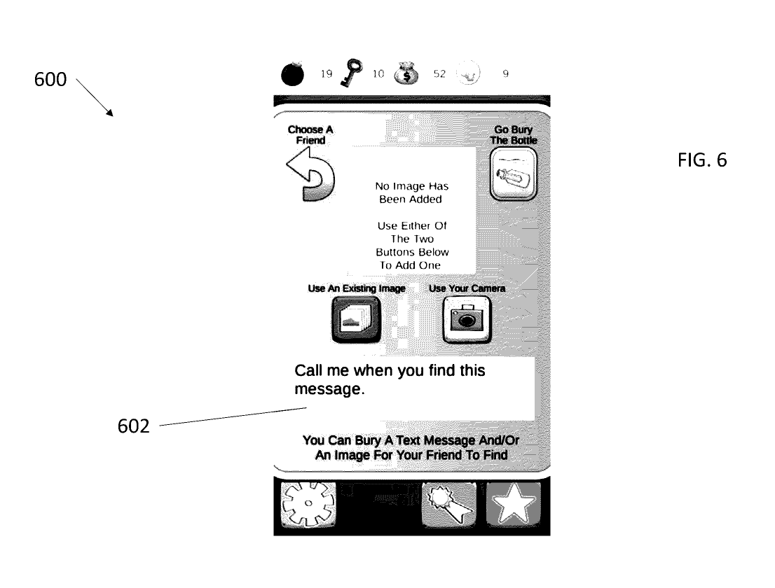

FIG. 6 shows an example embodiment diagram of a user interface “friend” image and caption sharing screen 600. In the example embodiment a user has typed in a message for a friend in text message field 602 that reads: “Call me when you find this message.”

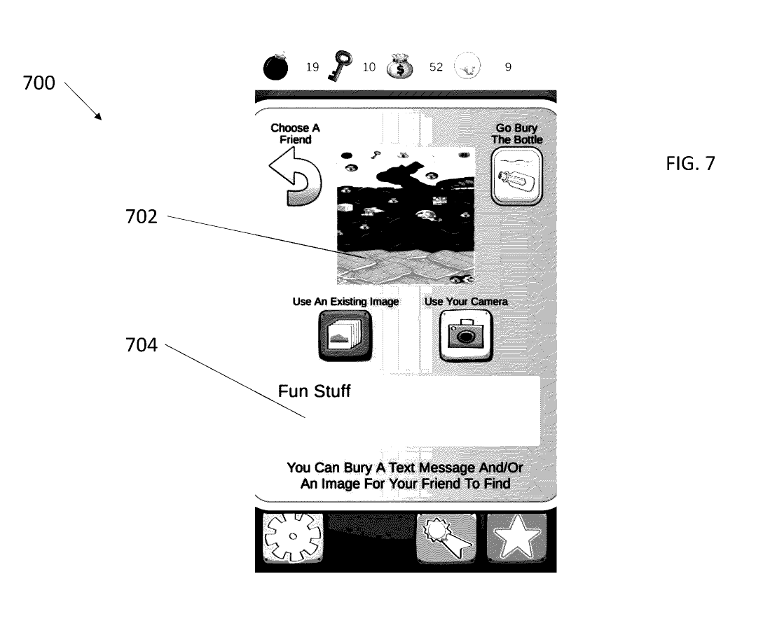

FIG. 7 shows an example embodiment diagram of a user interface “friend” image and caption sharing screen 700. In the example embodiment a user has selected a screenshot of a game from device memory, as shown in image window 702 and typed in a caption reading “Fun Stuff” in text message field 704.

FIG. 8 shows an example embodiment diagram of a user interface in-game location selection screen 800. In the example embodiment a user has previously chosen media content to share with their friend, as entered in the example embodiments of FIGS. 4-7. Here, the user is shown an in-game layout of a game in image window 802 where the user can choose where to embed their chosen content in their friend's game. Here this content is embedded in the form of a bottle 804. In the example embodiment this can include a choice of at least one location among many different levels 806a-806e of the layout in image window 802. In other embodiments this could include selecting a location in a forest, a quadrant of a planet in space, a room in a hotel, a depth and latitude and longitude in an ocean or many others. Once a location has been selected, the user can confirm their choice of location by selecting a confirmation button 808, here represented by a “Bury the Bottle” button 808. Users can also navigate back to a “friend” image and caption sharing screen (e.g. 700 of FIG. 7) in order to change a message by selecting a change message button 810.

In some embodiments a “BuryTheTreasure” function can include a user selecting the “Bury the Bottle” button 808 the server system iteratively going through a similar process as described above with respect to the FIG. 8 called “GrabTheRightPrize.” This can be used to determine if a user and associated prize are valid and match each other. Then the system can transfer the prize from the user's game data to a selected friend's client device or a database (e.g. Account database 150 of FIG. 1C), which can be accessed by the friend's client device. A Push Notification can be created and sent to a Push system to be delivered to the friend's client device, in order to inform them that they have received a new prize. As such, a “BuryTheBottle” function can have the same structure as the “BuryTheTreasure” function; user selected text, image, and bury position is sent over to the selected friend's game data.

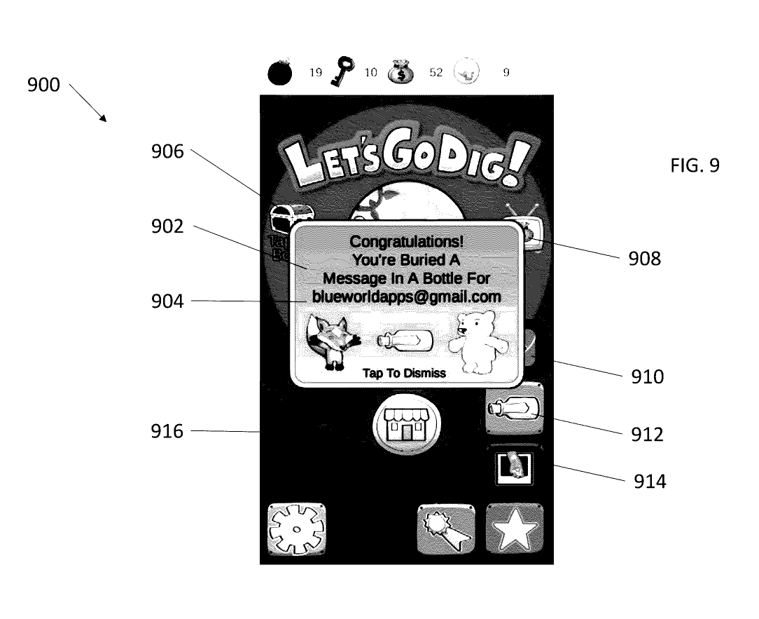

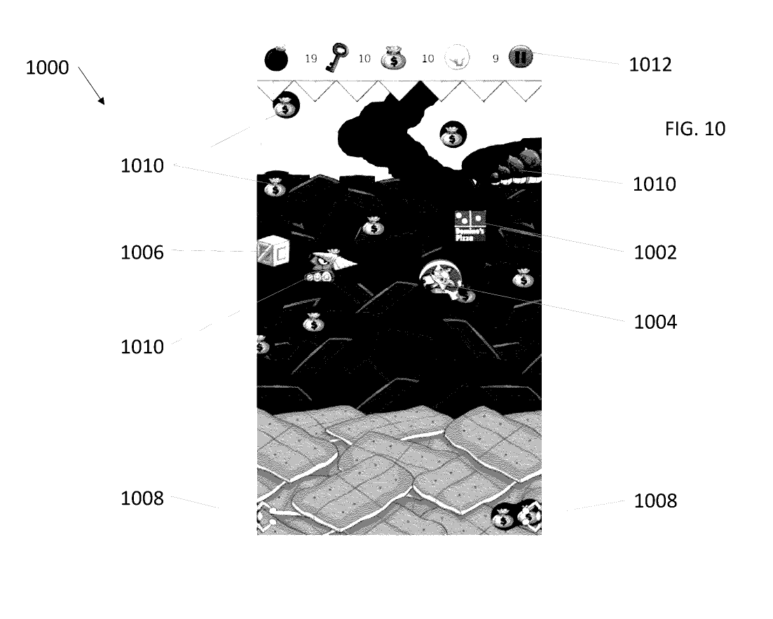

FIG. 9 shows an example embodiment diagram of a user interface in-game location selection confirmation screen 900. In the example embodiment once a user has selected a location to embed content in a friend's game, the user can be shown a confirmation message 902 on the user display of the user device that includes the username 904 of the friend where the content was sent. Additionally, in many embodiments, a push notification can be sent to the friend's user device that can inform the friend that they have a friend who has interacted with their game and hidden a prize or message for them. In instances where a friend has not yet created a user account, the system can send them a SMS message, multimedia message, email or other notification that they have a friend who is attempting to interact with them via the game. Various other buttons are also shown on confirmation screen 900. A prize list button 906 allows users to select one or more prizes from a list of available prizes. These can be organized in numerous different fashions including by prize provider or third party entity; by prize type, such as: discounts on food, discounts on merchandise, free merchandise or others; by expiration date; by location; by amount; or various others. A bank button 908 can provide a display of a user's in-game currency, rewards, or other non-external or real-world prizes. In some embodiments users can purchase in-game currency with real-world currency or may accrue in-game currency using geo-locating tracking monitors of a user device when visiting particular real-world locations. A video or other advertisement button 910 can allow users to view advertisements for other games, view advertisements for affiliated merchants or products or other advertisements. In some embodiments, users can watch advertisements and be rewarded with in-game or real-world benefits. A message in a bottle button 912 can allow users to create or compose messages to other users and include prizes they have accrued. A personalized message button 914 can allow users to include hyperlinks, send picture or video messages or other content related messages. A home button 916 can take users to a home screen display. Once a user has captured, won or otherwise accessed a prize, they can be shown a user interface screen with prize information, as in the example embodiment of FIG. 10.

FIG. 10 shows an example embodiment diagram of a user interface in-game screen 1000 with commercial prize icon 1002. In some embodiments, prizes for use in the real-world or other tangible prizes can be displayed in the form of logos, trademarks or other indicators. In some embodiments, these can be stored or hidden in treasure chests or other indicative items. In the example embodiment a user can have a playable character or avatar 1004 representing their location in the virtual world of the game. In some embodiments, such as First Person Shooter (FPS) games, puzzle games, or others, there may be no playable character visible to the user. In other embodiments, such as in real time strategy (RTS) games, turn based strategy games, or others, a user may control many characters.

Various interactive objects (buttons, switches, blocks, boxes etc.), non-interactive objects (trees, walls, stones, etc.), prizes (treasure, coins, jewels, etc.), enemies, Non-player characters (NPC's), avatars of other users, power-ups (fireballs, shields, wind effects, etc.), backgrounds, lighting effects, and other visible graphics may be shown in a given game screen. In the example embodiment, a box or crate 1006 can store and otherwise include in-game usable prizes. These can include keys, bombs, shields power-ups and other in-game items. Money bags 1010 can include in-game currency that can be used to purchase power-ups, weapons, virtual rewards, commercial rewards, new characters, new items or others. Non-player characters 1010 can include enemies who attempt to harm or hinder playable character 1004. Elements 1008 can be enemies or other obstacles that a user has avoid. As shown in the example embodiment, they are electricity generating enemies that can scroll up and down the screen and shoot electricity bolts that the user has to avoid in order to maintain their character's items, money, health or other important attributes.

Commercial prizes can be represented by specialty icons 1002 and may be hidden in chests, bottles, or other visible indicators, may be out in the open such as a coupon laying on a table in a room, or may be invisible and only appear if a user maneuvers their character over a particular location or selects a particular portion of a screen. In the example embodiment, a Domino's Pizza trademark is shown, representing a commercial prize the user can capture. Users can also pause the game by selecting a pause button 1012.

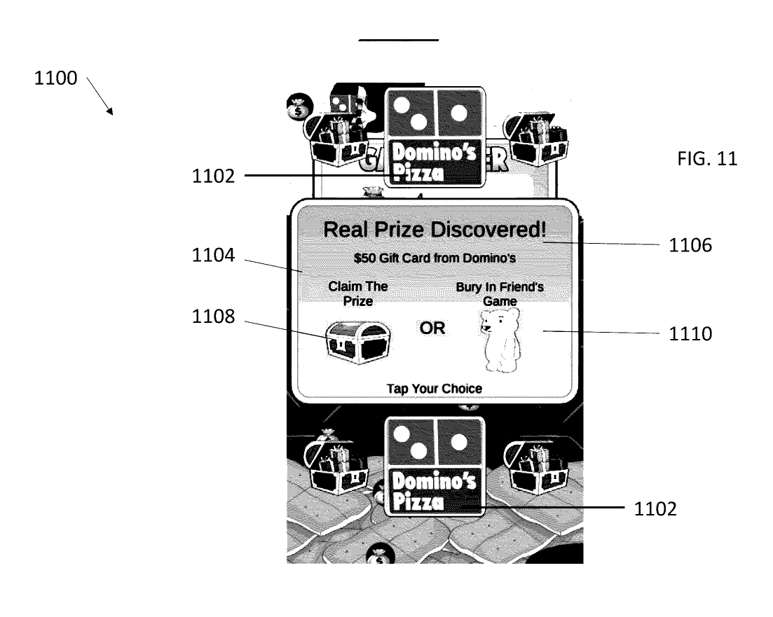

FIG. 11 shows an example embodiment diagram of a user interface user notification screen 1100. In the example embodiment a user has found, recovered or activated a commercial prize, indicated by icons 1102. The system can notify the user of the prize in a prize description window 1104, including information 1106 such as a “$50 gift card from Domino's.” A user may also be presented with an option to keep the prize for themselves by selecting a claim prize button 1108, re-gift to a friend by selecting a re-gift button 1110 or, in some embodiments, even split with a friend (not shown).

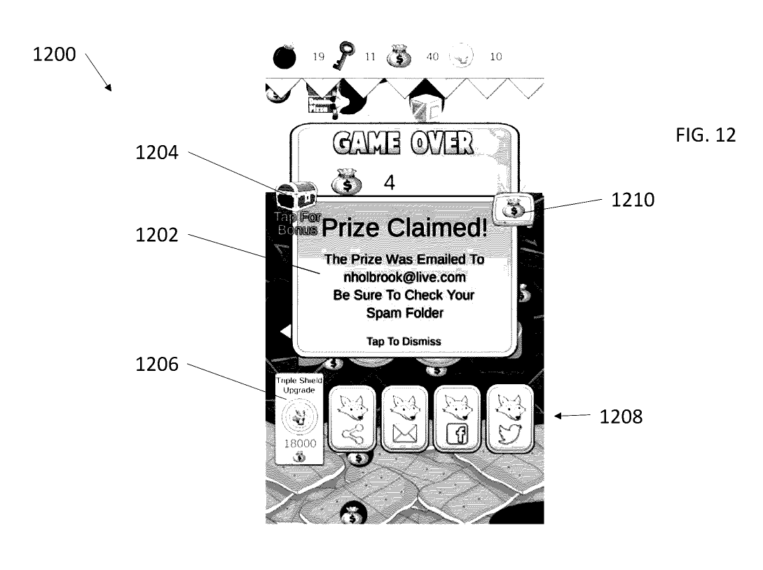

FIG. 12 shows an example embodiment diagram of a user interface commercial prize claim screen 1200. In the example embodiment, if the user chooses to claim the prize from a user notification screen, as shown in FIG. 11 and described above, the user can have the prize delivered to a real or virtual location. In some embodiments virtual locations can include another device application, a bank account, a credit card account, an email address, a social media account or others. As shown, in information window 1202, the prize has been sent to an email account and the system states “Prize Claimed! The Prize was emailed to nholbrook@live.com. Be sure to check your spam folder.”

Additional features are also shown. For instance, users can select a bonus button 1204 to receive additional awards. Users can also view game upgrades for purchase with in-game currency by selecting one or more upgrade buttons 1206 or store buttons. Here, upgrade button 1206 indicates that the user can buy a “Triple Shield Upgrade” for 18,000 of in-game currency. Users can also share their achievements, prizes or other gameplay attributes by selecting one or more third party information sharing buttons 1208. These can create and share information via linked third party website accounts such as Twitter, Facebook, email, LinkedIn and others. A bank button 1210 can allow users to view a display of a user's in-game currency, rewards or other non-external or real-world prizes.

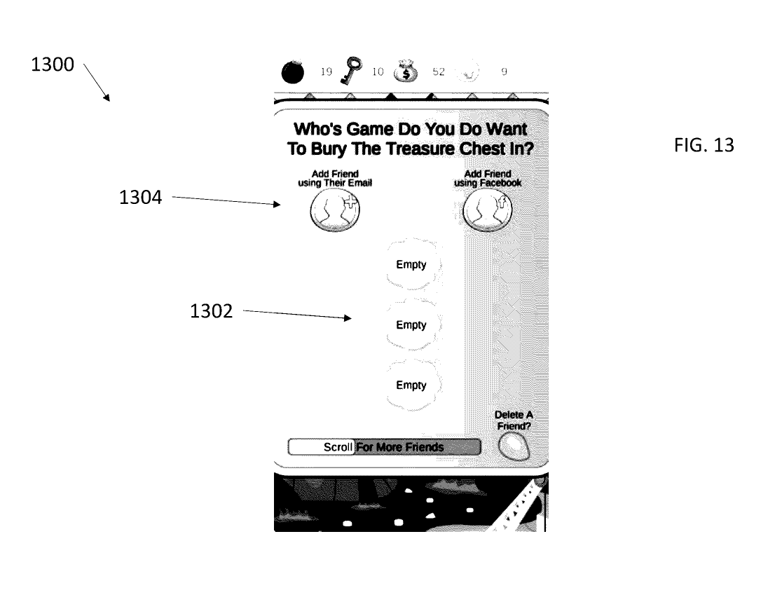

FIG. 13 shows an example embodiment diagram of a user interface commercial prize sharing screen 1300. In the example embodiment, if the user has chosen to re-gift the prize from a user notification screen, as shown and described with respect to FIG. 11, the user can select a friend from a list of friends 1302 to receive the prize. In some embodiments this can include simply forwarding the prize to a friend's user account, email account, social media account, or other account by selecting an appropriate button (not shown). In the example embodiment shown, the user has the option to include the prize in a friend's game, thus potentially increasing enjoyment of the friend and engagement with the game, since the friend will have a new in-game objective of finding and claiming the prize. Friends can also be added or removed from this screen by selecting email, social media or other connecting features, such as the functionality shown and described with respect to FIG. 3.

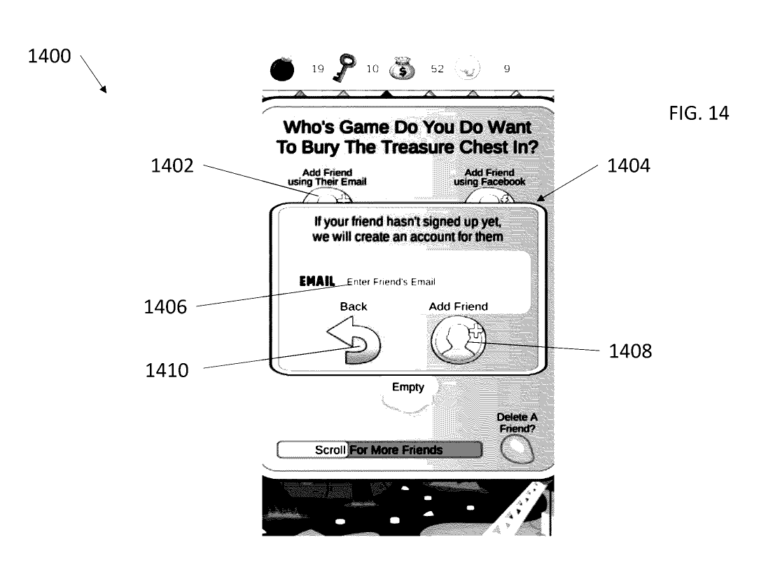

FIG. 14 shows an example embodiment diagram of a user interface commercial prize sharing screen 1400. In the example embodiment, a user can be presented with the option to re-gift a prize to a friend who has not yet created a user account or otherwise signed up with the system, as indicated by the “Empty” spots in the friends list shown in FIG. 13. Once the user has selected an add friend button, the user can then add the friend by using a linked social media account listing or by entering identifying information such as a phone number or email address in an appropriate field using a user interface. Here the user has selected an “Add friend using Their Email” button 1402, causing the device to display an email entry window 1404. The user can then enter a user's email information in an entry field 1406 using a user interface before selecting an “Add Friend” button to confirm that the user wishes to have an invitation sent to the friend's email. As previously mentioned, in other embodiments users may select friends to add them from a listing populated using a linked social media account that may include names, usernames, images or other identifiers. The user can also choose to select a “Back” button 1410 in order to close email entry window 1404.

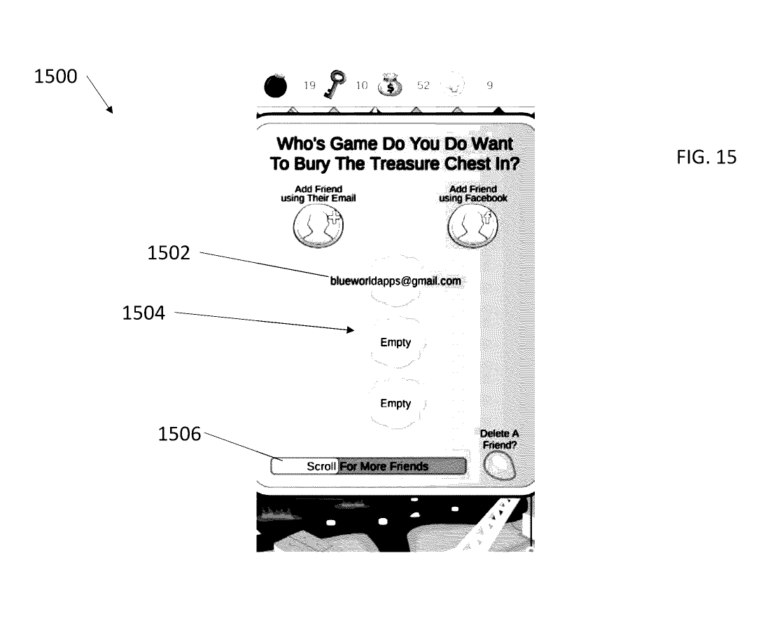

FIG. 15 shows an example embodiment diagram of a user interface commercial prize sharing screen 1500. In the example embodiment, the user has previously added a friend's email address “blueworldapps@gmail.com”, as indicated by friend identifier 1502 which is displayed in a list of friends 1504. In some embodiments, list of friends 1504 can include identifiers that may be modified by users using a user interface in order for users to more easily identify friends. For example, the user may wish to enter a friend's name, nickname, image or other information in place of a phone number or email address. In some embodiments, the game or application can access non-transitory memory of the user device in order to select personal images. Here, if the user decides to re-gift their prize to the friend with the “blueworldapps@gmail.com” identifier 1502, they can select it before an in-game selection location screen will be displayed. Also included is a scroll indicator 1506 which can display a progress bar for listing 1504, where users may have many friends. Scrolling can be accomplished by click-and-drag, swiping or other user interface tools. In some embodiments, multiple friends or groups of friends can be selected for sharing content.

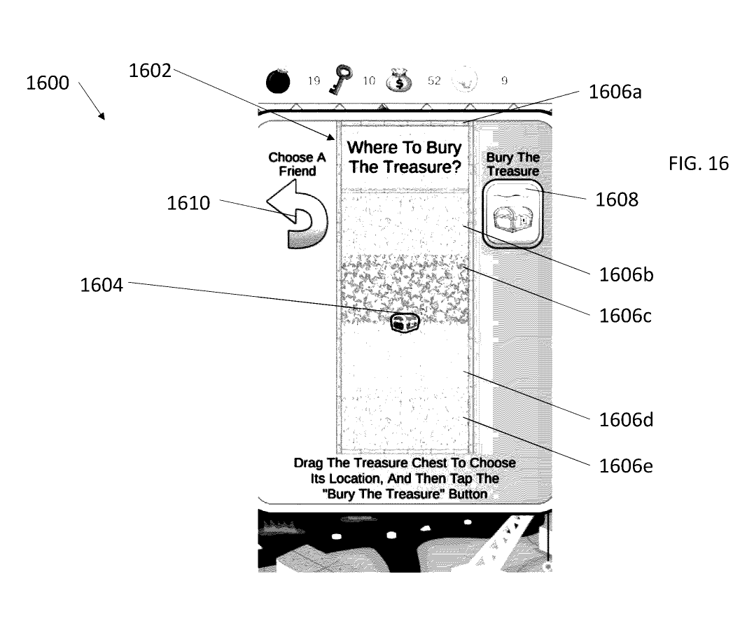

FIG. 16 shows an example embodiment diagram of a user interface in-game location selection screen 1600. This can function similarly to the in-game location selection screen of FIG. 8. As shown in the example embodiment a user has previously chosen media content to share with one or more of their friends. Here, the user is shown an in-game layout of a game in image window 1602 where the user can choose where to embed their chosen content in their friend's game. Here this content is embedded in the form of a treasure chest 1604. In the example embodiment this can include a choice of at least one location among many different levels 806a-806e of the layout in image window 802. In other embodiments this could include selecting a location in a forest, a quadrant of a planet in space, a room in a hotel, a depth and latitude and longitude in an ocean or many others. Once a location has been selected, the user can confirm their choice of location by selecting a confirmation button 1608, here represented by a “Bury the Treasure” button 1608. Users can also navigate back to a “friend” image and caption sharing screen (e.g. 700 of FIG. 7) in order to change a message by selecting a change message button 1610.

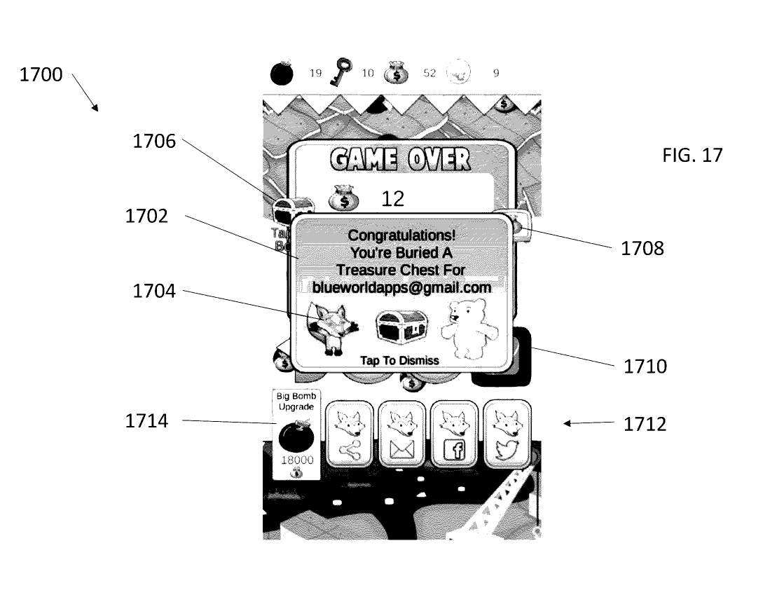

FIG. 17 shows an example embodiment diagram of a user interface in-game location selection confirmation screen 1700. This can function similarly to the in-game location selection confirmation screen of FIG. 9. In the example embodiment once a user has selected a location to embed content in a friend's game, the user can be shown a confirmation message 1702 on the user display of the user device that includes the username 1704 of the friend where the content was sent. Additionally, in many embodiments, a push notification can be sent to the friend's user device that can inform the friend that they have a friend who has interacted with their game and hidden a prize or message for them. In instances where a friend has not yet created a user account, the system can send them a SMS message, multimedia message, email or other notification that they have a friend who is attempting to interact with them via the game. Other buttons shown on confirmation screen 1700 include images or other depictions of characters 1704 that can be static or dynamic. A prize list button 1706 allows users to select one or more prizes from a list of available prizes. These can be organized in numerous different fashions including by prize provider or third party entity; by prize type, such as: discounts on food, discounts on merchandise, free merchandise or others; by expiration date; by location; by amount; or various others. A bank button 1708 can provide a display of a user's in-game currency, rewards, or other non-external or real-world prizes. In some embodiments users can purchase in-game currency with real-world currency or may accrue in-game currency using geo-locating tracking monitors of a user device when visiting particular real-world locations. A video or other advertisement button 1710 can allow users to view advertisements for other games, view advertisements for affiliated merchants or products or other advertisements. In some embodiments, users can watch advertisements and be rewarded with in-game or real-world benefits. Also included are one or more of various third party sharing buttons 1712 that can allow a user to share their achievement, information or shared item description via various third party platforms such as social media, email, SMS text message or others.

An upgrade button 1714 allows users to purchase upgrades or other items using in-game currency, real world currency or both. In some embodiments this in-game currency can be gained when items are shared or claimed by friends. As shown in the example embodiment, the upgrade button 1714 shown, “Big Bomb Upgrade,” costs 18000 bags of money and since player only has 52, player cannot yet afford this upgrade.

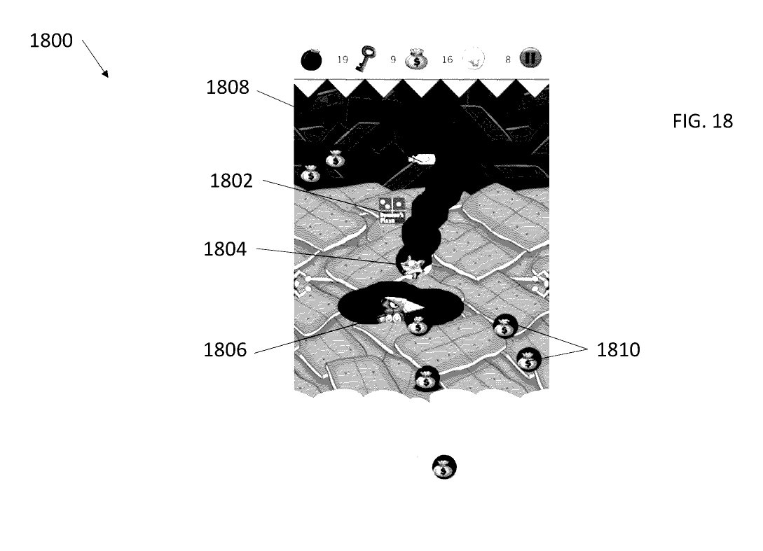

FIG. 18 shows an example embodiment diagram of a user interface in-game screen 1800 with commercial prize 1802. In the example embodiment the user interface shows a user character represented by an avatar 1804, here a fox, and an enemy 1806, here a robot with drill nose. Commercial prize 1802 is shown as a “Domino's Pizza” logo which could be a coupon or other promotional material. A media content placement or shared prize from another user is also shown, in the form of a message in a bottle 1808. Various additional prizes in the form of in game currency are represented by indicators 1810, here in the form of money bags.

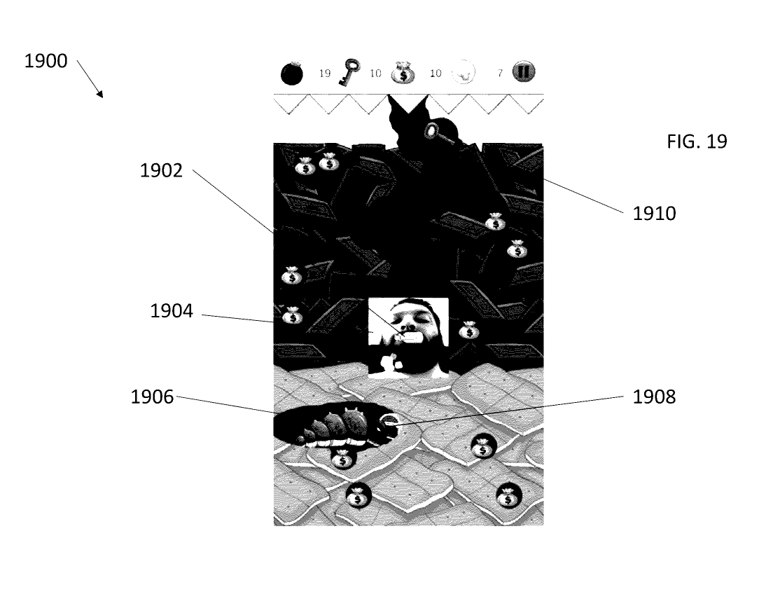

FIG. 19 shows an example embodiment diagram of a user interface in-game screen 1900 with “friend” interaction. In the example embodiment, the user has maneuvered their character (obscured) to a message in a bottle 1902 and a preview 1904 of the message stored inside is displayed onscreen. Here, the friend has included a picture which the user can view, shown as preview 1904. In some embodiments messages from friends can be stored in a log while in other embodiments they may only appear for a brief amount of time before disappearing. Also shown is an enemy avatar 1906, here a caterpillar guarding a treasure chest 1908. In some embodiments, prizes may disappear if users do not claim them within a certain amount of time. Additionally, a key icon 1910 is shown. Key icon 1910 can be required to unlock treasure chest 1908 or other content within the game or affiliated user interface screens.

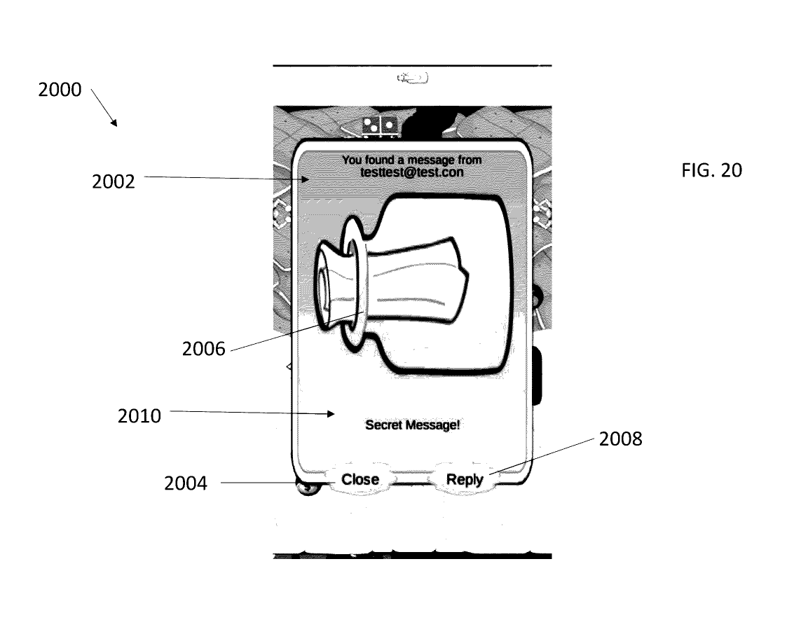

FIG. 20 shows an example embodiment diagram of a user interface user notification screen 2000. In the example embodiment the user is notified that they have found a message from another player within a window 2002. The user has the option to close, open, and reply to the message by selecting a close button 2004, open button 2006, or reply button 2008. If the user closes the message, the user can view it at a later time in some embodiments from a home screen, log screen, pause screen, or other screen. If the user elects to reply without first viewing the message, they can send a media content message of their own back to the friend who sent the message. If the user elects to view the message, they can open it and view the message, for instance in a field 2010.

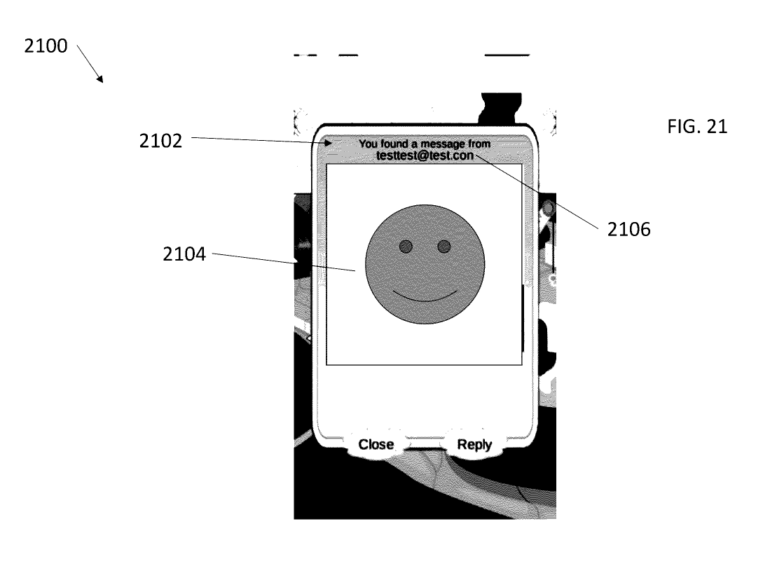

FIG. 21 shows an example embodiment diagram of a user interface user notification screen 2100. In the example embodiment, the user has elected to open the message sent by a friend and is shown the content of the message in window 2012. Here the content is a picture 2104, and the friend's identification 2106 who sent it, here testtest@test.con.

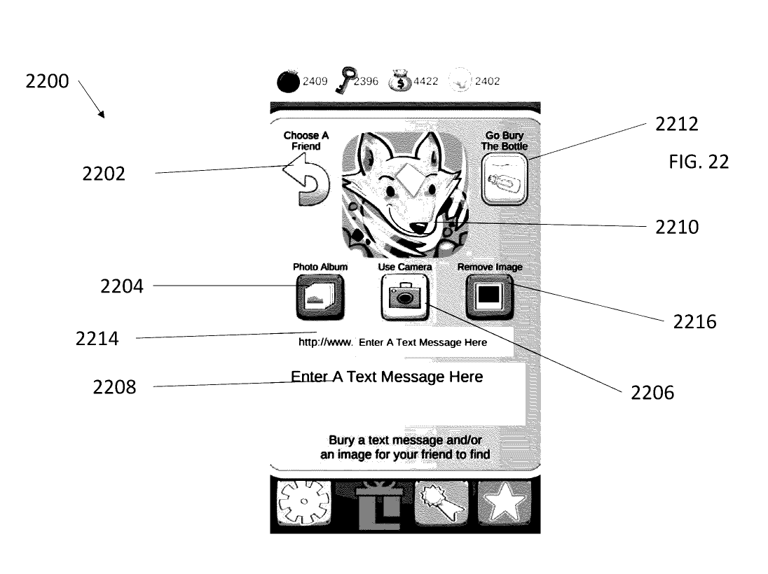

FIG. 22 shows an example embodiment diagram of a user interface messaging screen 2200 with hyperlink sharing functionality. In the example embodiment, a choose a friend button 2202 allows a user to return to a previous screen and select one or more different friends to engage. Users can have the opportunity to include an existing image stored in non-transitory device memory by selecting a use an existing image button 2204, use a device camera to capture an image by selecting a use your camera button 2206 and enter text messages in a text message field 2208 by using a device interface. Users can also enter text hyperlinks in one or more text hyperlink entry fields 2214 by using a device interface. In some embodiments, preset hyperlinks can be included and selected using drop-down menus, radio buttons or others. Likewise, in some embodiments preset text can be included.

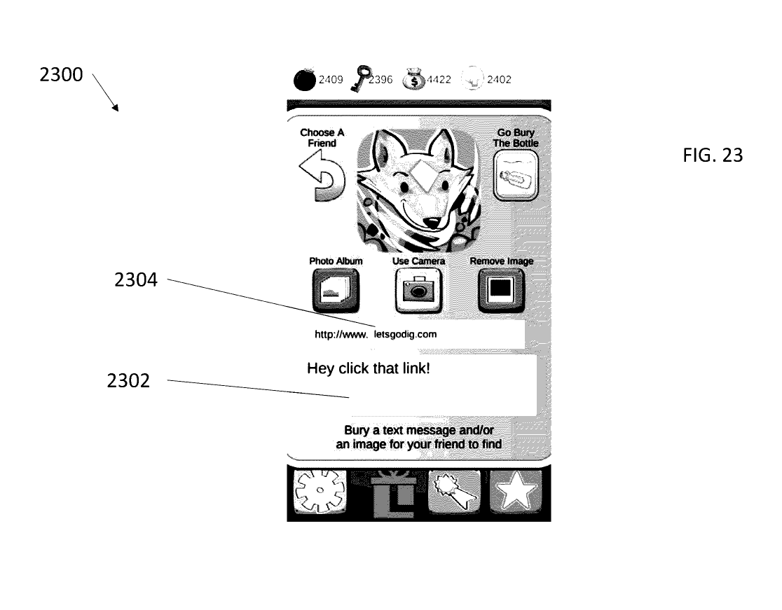

Additional functionality is contemplated in other embodiments including using voice recordings or songs, video clips or captured videos, links to websites and other content. Users can then preview a prize bottle in image window 2210 and implant their chosen content into their friend's game by selecting a go bury the bottle button 2212. In the example embodiment this is done by selecting “Go Bury the Bottle” button 2212, although in other embodiments this can be done in various other ways. Selecting the “Go Bury the Bottle” button 2212 can take the user to a user interface in-game location selection screen (e.g. 2300 of FIG. 23).

In some embodiments, hyperlinks, messages and images can be trackable revenue generating links to affiliates, advertisers, or networks or trackable for other reasons or purposes. In some embodiments these can be provided or joined with third-party entity tracking applications or features.

Also, in some embodiments assets provided in the game can be programmatically spawned within a user's environment nearby or otherwise indicated to users. As such, one user can implant assets in selected positions within the environment of another user or network of users. This can allow third party entities to implant prizes in the games of selected or global groups of users.

FIG. 23 shows an example embodiment diagram of a user interface messaging screen 2300 with hyperlink functionality. In the example embodiment a user has typed in a message for a friend in text message field 2302 that reads: “Hey click that link!” Also, here the user has entered “letsgodig.com” into a hyperlink entry field 2304.

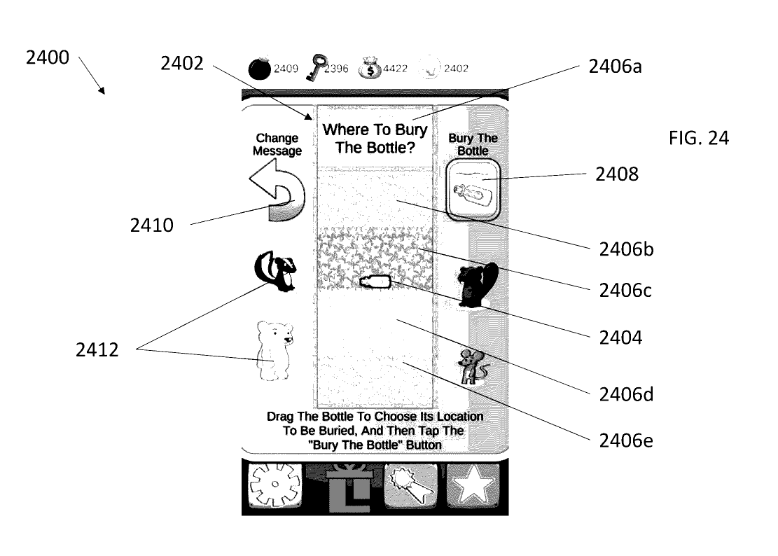

FIG. 24 shows an example embodiment diagram of a user interface in-game location selection screen 2400. In the example embodiment a user has previously chosen media content to share with their friend. Here, the user is shown an in-game layout of a game in image window 2402 where the user can choose where to embed their chosen content in their friend's game. Here this content is embedded in the form of a bottle 2404. In the example embodiment this can include a choice of at least one location among many different levels 2406a-2406e of the layout in image window 2402. Once a location has been selected, the user can confirm their choice of location by selecting a confirmation button 2408, here represented by a “Bury the Bottle” button 2408. Users can also navigate back to a “friend” image and caption sharing screen (e.g. 2200 of FIG. 22) in order to change a message by selecting a change message button 2410. Various character avatars 2412 are also shown.

It should be understood that the term “commercial prize” used herein need not be something of monetary value or even from a commercial enterprise, although it may be. Examples of the varied uses can include an invitation to a non-profit organization dinner, a ticket to a governmental function, coupons with cash value, electronic funds, credit to an online shopping website or retail store, a notification about a members-only VIP event, lottery tickets, and any number of other prizes, invitations, notifications, or others.

In many embodiments, one or more functions described herein can include one or more types of error logging that inform system administrators if something goes wrong or there are errors in different parts of the logic behind system functionality. Generally, none of these error messages will log any user's identification information. However, some or all user game data can be viewable using a system administrator's database dashboard, with an exception being user passwords. User passwords can be stored behind a layer of encryption to protect them.

Some embodiments of the invention can include location determination of user devices in order to attract users to a particular location or present users with offers. For instance, the system can include location monitoring of user devices using Wi-Fi, Bluetooth, cellular or other networks. Based on preset conditions, when a user device is brought into proximity with a defined area the system can notify the user via the user device. This can provide advertising and prize opportunities for users. For example, a pedestrian walking down a street may enter a predefined area for a particular coffee shop. The system can then notify the pedestrian via a message or other notification that they have received a prize from the establishment and directions on how to redeem as well as directions on how to find the coffee shop location. This can take various forms including “Joe's Coffee has hidden a Free Cappuccino Voucher for you to find. Redeem it at Joe's Coffee located twenty feet ahead and on the right.” Another example is that of a driver being notified: “BigGas just hid a Free Gallon of gas Voucher for you to find. Redeem it at the BigGas location 0.5 miles ahead on the left.”

Time sensitive information can be included along with location information in some embodiments or standalone in other embodiments. For instance, in the coffee shop example above, the offer may only occur in the morning between 5 am and 9 am. Similarly, a bar or nightclub may have an offer which only notifies users between 7 pm and 12 am. Time sensitive information can also include monitoring how often a user logs into the application and rewards users who log in often. Different thresholds can be used for this, for example if a user logs in three times per day for three days they may receive a special offer.

Other monitoring of user devices can occur in some embodiments. For example, the system can check to determine whether a user has a fashion store shopping application installed on their device. If they do, the system can include offers from the fashion store in the game. Similarly, the system can be given access to a user's email account and search emails for particular keywords and make offers based on preconditions.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A system for promoting a social gaming environment via a computer network, comprising:
a server, communicatively coupled to the network and including a prize database storing at least one prize; and
a first user device, communicatively coupled to the network and having instructions stored in non-transitory memory that, when executed by a processor of the user device, cause the processor to:
communicatively couple with the server via the network;
receive at least one prize from the prize database;
display a gaming environment on a user interface of the first user device, wherein the prize is included in the gaming environment and can be found by a first user;
selectively create a message for inclusion in an interactive gaming environment for a second user; and
send the message via the network to a second user device of the second user.

2. The system of claim 1, wherein the message includes the prize found in the gaming environment on the first user device.

3. The system of claim 1, wherein the message includes an image or video captured by a camera of the first user device.

4. The system of claim 1, wherein the prize database is accessible via the network by at least one third party entity and the prize has monetary value related to the third party entity.

5. The system of claim 1, wherein, upon receiving the message from the first user device, the second user device automatically notifies the second user that they have received a message.

6. The system of claim 1, wherein the message can be selectively placed in the interactive gaming environment for the second user at a location chosen by the first user.

7. The system of claim 1, wherein the server further comprises an account database for storing user accounts and is operable to store information for the second user before the second user has created an account.

8. The system of claim 1, wherein a third party entity can send prizes to multiple users simultaneously via the network.

9. The system of claim 1, wherein the prize can be sent to third party email accounts.

10. A computer implemented method for promoting a social gaming environment on a user device via a computer network, comprising:
instructions stored in non-transitory memory of the user device that, when executed by a processor of the user device, perform the steps of:
communicatively coupling with a server via the network;
retrieve at least one prize from the server;
selectively display a gaming environment on a user interface of the user device;
selectively display the prize on the user interface when found in the gaming environment; and
selectively create a message for inclusion in an interactive gaming environment for a second user.

11. The method of claim 10, wherein the message includes the prize.

12. The method of claim 10, wherein the message includes at least one image.

13. The method of claim 10, wherein the prize has monetary value related to a third party entity.

14. The method of claim 10, further comprising:
automatically notifying a user that they have received a message from another user.

15. The method of claim 10, wherein the message can be selectively placed in the interactive gaming environment for the second user at a location chosen by a first user.

16. The method of claim 10, wherein the prize can be sent to third party email accounts.

17. The method of claim 10, wherein a third party entity can send prizes to multiple users simultaneously via the network.
